(19) United States
(12) Patent Application Publication
(10) Pub. No.: US 2024/0066910 A1
(43) Pub. Date: Feb. 29, 2024

(54) MARK IDENTIFYING A COLLECTIBLE AS ORIGINATED BY ITS CREATOR OR MANUFACTURER

(71) Applicant: TAG P, LLC., Los Angeles, CA (US)

(72) Inventors: Stephen B. Kass, Los Angeles, CA (US); Greg Harrison, Los Angeles, CA (US); Scot Maxwell, Los Angeles, CA (US); Matthew R. Cook, Los Angeles, CA (US); Michael B. Cook, Los Angeles, CA (US); Mark N. Cook, Los Angeles, CA (US); Max Korbel, Sherman Oaks, CA (US)

(21) Appl. No.: 18/456,407

(22) Filed: Aug. 25, 2023

Related U.S. Application Data
(60) Provisional application No. 63/373,546, filed on Aug. 25, 2022.

(51) Int. Cl. B42D 25/41; B42D 25/333; B42D 25/378

(52) U.S. Cl. CPC B42D 25/41; B42D 25/333; B42D 25/378

(57) ABSTRACT

Method and apparatus for identifying the authenticity of collectibles including sport and non-sport card collectibles. The apparatus comprises a marking device that places a mark on the collectible that is a unique characteristic of the collectible that authenticates the collectible as being an original collectible created, produced, or manufactured at a specific location, time or by the person or entity identified as such on the collectible. The original mark will remain attached to the collectible forever with the use of Blockchain and/or NFT technology. The original mark may be used to located the collectible.

### CROSS REFERENCE TO RELATED APPLICATIONS

This application claims the benefit of and priority to U.S. Provisional Application Ser. No. 63/373,546, entitled “MARK IDENTIFYING A COLLECTIBLE AS ORIGINATED BY ITS CREATOR OR MANUFACTURER” and filed on Aug. 25, 2022, which is expressly incorporated by reference herein in its entirety.

### TECHNICAL FIELD

This disclosure generally relates to authenticating sport and non-sport trading cards, and other collectibles including but not limited to comics, photographs, programs, tickets, brochures, or the like.

### INTRODUCTION

There has been a proliferation of collectible counterfeits largely resulting from advances in counterfeiter capabilities including but not limited to advances printing technology.

Concurrent with advances in counterfeiting capabilities, there has been one of the most accelerated increases in collectible values in history, particularly in sport and non-sport trading card values, creating increasing opportunity for high value collectible counterfeiters within the collectibles industry.

### BRIEF SUMMARY

The disclosure provides various aspects of a system and method for determining if a collectible is original and not a counterfeit or a not original collectible without the requirement for, and use of, identifying a specific characteristic of a counterfeit or not original collectible.

The disclosure provides various aspects of a system and method for determining if a collectible is original and not a counterfeit and, in some instances with the aid of Blockchain and/or NFT technology, permits the card to be resold in the future with assurance that the original mark has not been altered after the card has been placed in a holder (e.g., slab).

In an aspect of the disclosure, a method, a computer-readable medium, and an apparatus are provided. The apparatus may be configured to mark a collectible comprising a marking device that places a mark on the collectible that is a unique characteristic of the collectible that authenticates the collectible as being an original collectible created, produced, or manufactured at a specific location, time or by the person or entity identified as such by the manufacturer of the collectible.

### BRIEF DESCRIPTION OF THE DRAWINGS

FIG. 1 is a diagram illustrating an example of a layer of a collectible.

FIG. 2 is a diagram illustrating an example of a layer of a collectible.

FIG. 3 is a diagram illustrating an example of a layer of a collectible.

FIG. 4 is a diagram illustrating an example of a layer of a collectible.

FIG. 5 is a diagram illustrating an example of a layer of a collectible.

FIG. 6 provides an example of a borderless collectible.

FIG. 7 provides an example of a single border collectible.

FIG. 8 provides an example of a dual border collectible.

FIG. 9 provides an example of a collectible having four borders.

FIG. 10 is an exploded view of a multi-layered collectible.

FIG. 11 is a flowchart of a method of marking a collectible.

FIG. 12 illustrates an example computing environment with an example computer device suitable for use in some example implementations.

### DETAILED DESCRIPTION

Sport cards are generally images of one or more persons, or one or more events related to various domestic and international sports, including, but not limited to, Football, Basketball, Baseball, Hockey, Soccer, Cricket, Tennis, Boxing, Auto Racing, Wrestling, Bowling, etc.

Non-sport trading cards are generally images of fictional characters, people, historical personalities, celebrities, well known scenes such as historical monuments, including, but not limited to, all forms of entertainment, domestic and international, such as tv shows, movies, books, comics, cartoons, famous cities, cultural events, etc.

Among the fastest growing segments of the non-sport card collectibles are cards from trading card games (“TCG”) such as Pokémon, YuGiOh and Magic the Gathering.

Generally, the authentication of counterfeit sport and non-sport cards is by the identification of a counterfeit characteristic that is not consistent with the original version of the card.

When the identification of the counterfeit characteristic is discovered, it is generally disclosed to the public via any of several industry sources including social media bloggers, influencers, and message boards.

After the identification of the counterfeit characteristic is disclosed to the marketplace, the collectible is generally referred to as a “known counterfeit” or the identifying mark on the counterfeit as the “counterfeit tell”.

Each time a card is authenticated it is examined, in part, by human beings either aided or unaided by various means of looking at an object such as one or more scanner or image capture devices including a camera with or without use of a computer or other devices to determine if the collectible being authenticated, is a known counterfeit version of that collectible, and, if so, what is one or more counterfeit characteristics or tell(s) and does at least one exist on the collectible, being authenticated.

If a card that is being authenticated has been identified as a card with a known counterfeit characteristic and that counterfeit characteristic is identified on the card being authenticated, the card being authenticated is determined to be counterfeit.

Many counterfeit cards may not be identified by authenticators, experienced card collectors or manual graders because there may be no known counterfeit characteristic for a card at the time that card is being authenticated or, if known, it may not be recognized or it may be inadvertently unidentified.

A card that is not known to be an original or counterfeit card has no mark or characteristic that may be identified and is intended to denote that the card is genuine and produced by the original creator of the card (collectible).

A card that may not be a counterfeit, and there is a version of that card known to be a counterfeit with a known counterfeit characteristic, has no mark on it either on top, bottom or between any layer, intended to denote that the card that is not a counterfeit is an original card and produced by the original creator or manufacturer of the card (collectible).

A card that is a counterfeit but has no known counterfeit characteristic cannot be determined to be a counterfeit by its lacking any mark specifically designed and placed on the top, bottom or between any layer of a non-counterfeit version of the same card.

There is no color on the color spectrum that is unable to be reproduced as a counterfeit. However, a color may be reproduced as a counterfeit that may be undetectable as a not original (counterfeit) color.

A card may be an original and may be designed to be, at least in part, any shape including round, oblong, rectangle, square, triangle or any combination thereof.

There is no card shape that cannot be reproduced as a counterfeit and possibly be used to identify a counterfeit card. However, a card shape may be reproduced as a counterfeit and that counterfeit shape may be undetectable as not an original (counterfeit) shape.

A card may be an original and may be designed to be, at least in part, comprised of edges that may include straight, curved, wavy, deckle, beveled, or any other type of edge including any combination thereof.

There are no card edge types that cannot be reproduced as a counterfeit and possibly be used to identify a card that is counterfeit. However, an edge may be reproduced as a counterfeit and that counterfeit edge may be undetectable as not an original edge.

A card may be an original and may be designed to have any type of surface each of which may be reproduced, in whole or in part, in a counterfeit including, at least one or more of the following:
i. Paper—Standard common paper stock cards. Sets include Bowman Prospects, Topps Heritage, and Upper Deck
ii. Chrome—Cards topped with a reflective foil to give a “Holo” or “Refractor” effect. Sets include Topps Chrome, Panini Prizm, and Panini Select
iii. Canvas—Cards printed on a canvas stock. Sets include Upper Deck UD Canvas and SP Authentic Canvas Collection
iv. Parchment—Cards printed on parchment paper so that they are slightly textured. Sets include Panini Court Kings Blank Slate.
v. Acetate—Cards printed on acetate cardstock so that they are transparent. Sets include Upper Deck Ice Parallel, Panini Illusions Illusionists, and Panini Chronicles Magnitude
vi. Lenticular—Cards printed with lenticular lenses so that the images give the illusion of depth or movement when viewed from different angles.

Sets include Upper Deck 3D Stars, Fleer Thrill Seekers, and Topps On Demand 3DA specific surface type or characteristic may be a card marker that may possibly be used to determine if a collectible is a genuine card. However, the surface of the card may be reproduced as a counterfeit and may be undetectable as a counterfeit.

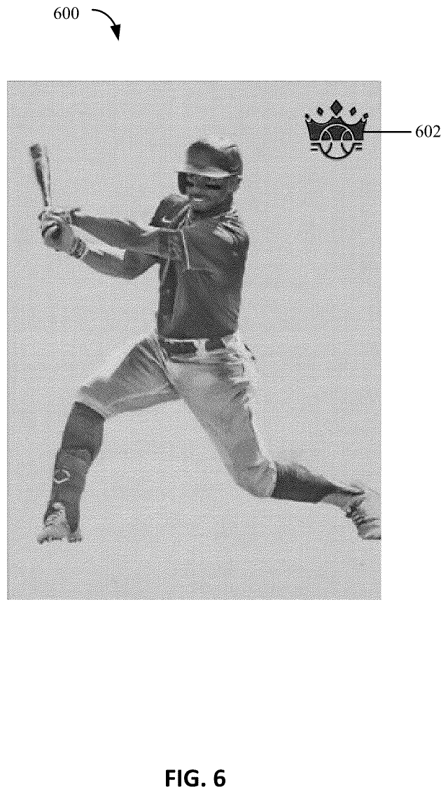

A card may be an original and may be designed to have any type of border around at least part of the perimeter of the card, or may include no borders. A border of a card is generally described as an area on the card surface, front and/or back, that identifies a printed portion of the card defined as that area between the edge of the subject image, or the image or text, boxed or unboxed, on the back, and the edge of the card stock the image is placed or printed upon. If a card has no border and the image on the collectible extends from edge to edge, the card may have at least one border marker such as but not limited to a team name, team logo, manufacturer name, player name, name plate, or any other marker placed on the collectible that may be used to identify the distance between the border marker location and the location of the nearest edge or other known aspect of the image, for example as shown in FIGS. 6-9.

FIG. 6 provides an example of a borderless card 600. The card in FIG. 6 may be completely or substantially void of any text or markers that form a border on the card. In some instances, logos 602 (e.g., manufacturer logos, brand logos or rookie card “RC” logos, or other logos or graphics that may correspond to an award received by the player on the card) may or may not be used to define a border. Such logos/graphics may be positioned in different places on different cards within the same set of cards depending on orientation print (e.g., portrait or landscape), action of the player in the photo, whether the image is a close-up, or the like.

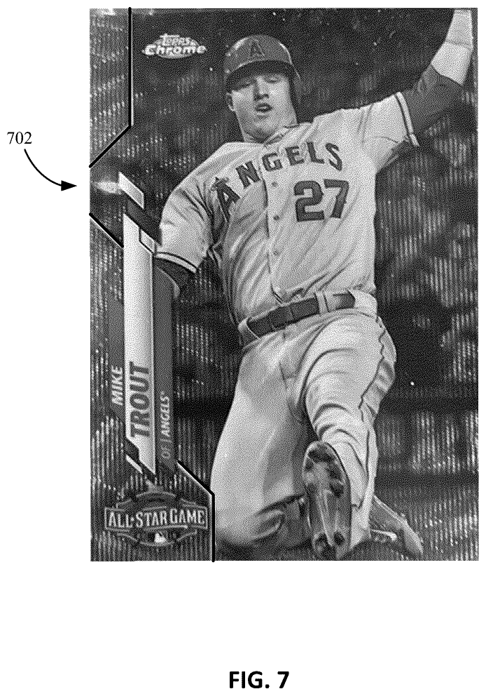

FIG. 7 provides an example of a single border card, where the only border is the left border 702 of the card. In some instances, the card may comprise a vertical bar on the left side of the card with a cut-out that forms the left border. In some instances, the border may be comprised of one or more geometric shapes that collectively comprise or form the border of the card. In some instances, player identity, team name, or logos related to awards or events may be within the one or more geometric shapes that collectively comprise or form the border of the card.

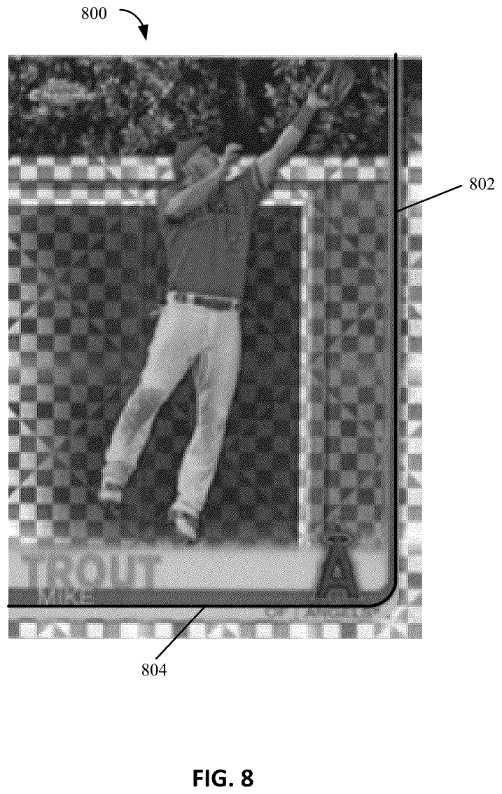

FIG. 8 provides an example of a dual border card 800, where a first border 802 is along an edge (e.g., the right side) of the card, and a second border 804 is along an adjacent edge (e.g., a bottom portion) of the card. In such instance, the card comprises a ribbon that extends from a top portion of the card along the right side towards the bottom, where the ribbon has a bend, a transition, or a curve, near the bottom right hand corner of the card, that extends towards the left side of the card along the bottom portion of the card. The bent ribbon forms the right border and the bottom border of the card. However, in some instances, the dual border card may be arranged in many different configuration and is not intended to be limited to the aspects disclosed herein. In some aspects, the dual borders may be on opposing sides, adjacent sides, or on the same side.

A three border card may be configured in a manner similar to the dual border card 800 of FIG. 8, but comprises an additional border extending along an additional side.

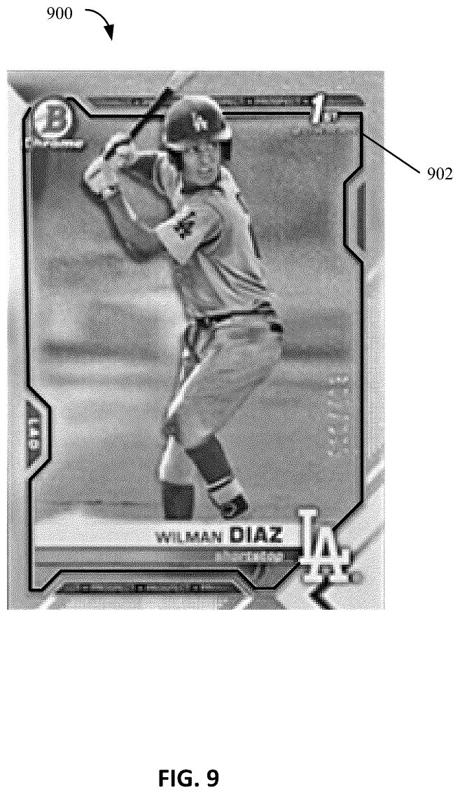

FIG. 9 provides an example of a four bordered card 900, where a border 902 extends along each side of the card. In the example of FIG. 9, the card is in the shape of a conventional trading card, such that the card is rectangular. In some aspects, the card may be in many different shapes and is not intended to be limited to rectangular cards. In some aspects, the border may extend along the edge of the card, in a parallel or substantially parallel manner, to form the border. However, in some aspects, the border does not have to extend along an edge of the card. In some aspects, the card may comprise a non-rectangular shape while the one or more borders may be in the form of a rectangular shape, rectangular-like shape, non-rectangular shape, or a portion thereof.

Border markers do not identify a card as genuine and they can, and have been, counterfeited.

More particularly, the disclosure relates to identifying the authenticity of the sport and non-sport card collectibles and other printed objects including event ticket, event programs, photographs, photograph facsimiles, brochures, or the like by identifying if the collectible is an original rather than if the collectible is not an original or is counterfeit. Authentication may be determined based on detection of a security or original mark which may be on or within the collectible and used as a security mark identifying a collectible as originated by its creator or manufacturer. Detection of the security or original mark may be detected by an unaided eye from at least one surface of the collectible or may be detected by a detection apparatus configured to detect the presence of the security or original mark. In some instances, the detection apparatus may utilize at least one of light, sound, electromagnetic signals, any other characteristic or identifying feature that impedes counterfeit versions of the collectible, unique to the collectible, or the like, or a combination thereof to detect the presence of the security or original mark.

Currency, often the subject of counterfeit attempts, incorporates security features within the paper or bill of the currency so that it may be identified as original and non-counterfeit rather than looking for a counterfeit “tell”.

Authentication is the means with which an original collectible may be differentiated from a counterfeit or otherwise non genuine versions of the collectible.

Any collectible determined to not be an original may be a counterfeit and may not need to be specifically identified as being counterfeit, only that it is not an original and that it may be counterfeit.

Today, there is not an existing manner of detecting a counterfeit card with certainty until a specific characteristic of the counterfeit card, differentiated from the original becomes known to the industry (e.g., the “tell”). Even in such an instance the counterfeit may go inadvertently undetected or undetected because the person viewing the card may be unaware of the counterfeit differentiation (the “tell”) that is known to the industry.

Often identification of a specific characteristic of a counterfeit card takes months, or years. At least one advantage of the disclosure is that detection of the security or original mark may be instantaneous, thereby eliminating or reducing the amount of time or expense utilized to determine the authenticity of the collectible and alerting those purchases of the counterfeit collectible that it is not an original prior to a known differentiation the “tell” becoming known to the industry.

Until the collectors and traders of cards that they purchase in marketplace become aware of the specific characteristic of a counterfeit card, the counterfeit may change hands many times and possibly at ever increasing prices leaving the last man standing at the time the specific characteristic of the counterfeit becomes known possibly owning or liable to the owner for a card that is without value.

Not only does the owner of the card (last man standing) when a specific characteristic of a counterfeit card becomes known, lose his investment, but often many people who have traded in that card lose confidence in the market and begin to adjust the value they will pay for a card by a risk factor to minimize the risk that the card will be determined in the future to have a specific characteristic of a counterfeit at the time that they are the owner of the card (last many standing).

The purchase and sale of collectibles often multiple times in a year and more commonly over the life of a card, including sport and non-sport cards, has become, for many fans, much more than a hobby. For many in the collectibles trading industry, their livelihood depends of the authenticity of the collectibles that they purchase and sell, so too, their reputation that affords them the continuing opportunity to pursue their business and sustain their livelihood.

The industries that are supported by collectibles including cards is described by many as several billion dollars each year. Many tens of billions of dollars in ancillary business such as plastic, steel, printing, distribution, retailers, marketplaces, lenders, conventions, travel, and others, that support the industry will also be impacted if the industry is negatively impacted by undetected counterfeit collectibles.

Many tens of billions of dollars in ancillary business are supported by collectibles including cards also includes social media, auctions, marketplace platforms, NFT's, tokens, fractional share selling, technology, slab materials, printing and ink supply companies, various welder machines, card and flip paper, card stock, card manufacturers, candy manufacturers, lenders, national and regional and local conventions, travel distributors, and employment of tens of thousands of people, security firms including armed and unarmed guards, shipping companies such as FedEx, USPS and others, packaging materials suppliers, promoters, marketing companies, grading companies, authenticators, and athletes to name a few.

There is a great deal of potential value in building a card or other collectible collection and it could take years of research, time, and expense to do so. When a collector is interested in building a valuable card collection, it is very important for the collector to know that the collectible is a genuine collectible as created and produced and/or printed, by the creator or manufacturer of the collectible. When a collector completes a valuable custom set, manufactured set or cards unrelated to a similar set, player, manufacturer and sells the collections that the collector compiles, one card determined to be counterfeit from among all the cards in that set may cause the value of the remaining cards in that set to lose value, in part to, it becoming known in the industry that a particular collector/seller has previously sold a counterfeit card.

When a high value card is sold and subsequently determined to be counterfeit, questions arise as to who is responsible and who will absorb the loss in value? Is it the original grader who failed to identify the card as genuine (non-counterfeit, is it the card owner who relies on the grader grade of condition opinion? Is it a future buyer of that collectible when the collectible is resold? Commonly, the collectible value increases up to the time it is determined to be a counterfeit.

Often the most recent seller of the counterfeit card must decide if they are willing to indemnify the person who purchased from them. Even if this happens, most commonly, the indemnity is for the price paid for the card not what it was able to sold for at the time immediately prior to it being determined to be counterfeit (often years).

The counterfeiter of a collectible including a card, takes no financial risk of market value and the means to get a card into the marketplace without identifying themselves personally may be accomplished. Counterfeit cards are difficult enough to identify, let alone identify who created the counterfeit. It is a perfect storm, very large industry, very old industry, very wealthy collectors in the industry, manufacturers making sets and cards in limited and seriated numbers to make them scarcer and more valuable, many collectors, large industry, very large marketplaces, and . . . counterfeiters many times from outside the U.S. creating counterfeit cards to capitalize of the fact that the counterfeit will likely enter the market before it is identified with its “tell”.

In the commonly used marketplaces, or auctions or private sales directly between seller and buyer or at any of the hundreds or thousands of the retail collectible stores or collectible shows and conventions, attempts are made to assure the buyer of the collectible that it is genuine/authentic or not counterfeit.

Card authentication experts and card grading technologies that evaluate the condition of the card are doing their best to identify non original or counterfeit collectibles such as sport and non-sport cards before they are sold in the various marketplaces.

As the value of collectibles increases, as it has, to values that can exceed millions of dollars for a single card and often exceed one hundred thousand dollars for a single collectible, counterfeiters are attracted to those collectibles and use their counterfeit expertise and possibly combined with advanced technologies to create counterfeit versions of the collectible and sell them to buyers who do not have the knowledge, skills or professional assistance from experts to identify any specific characteristic of the collectible to determine that it is an original and not a counterfeit.

The inability of the buyers and/or grading companies to consistently identify the characteristic of the counterfeit leaves the buyer in the position of purchasing a collectible with and relying on the seller that the collectible is genuine and not a counterfeit. The seller is relying on someone else's opinion and that person does not consistently know what the “tell” may be on a specific card. It is the proverbial “one eyed leading the blind”. Collectibles are often considered similar to a currency and the holders rely upon the belief that the collectible is genuine, authentic and not a counterfeit.

A primary tenant of the collectible industry is “know your seller”, which in today's marketplace is virtually impossible to adhere to on a meaningful basis. Counterfeit collectibles are often identified after they are sold on the largest public marketplaces.

Purchasers are often incurring loss of investment when, after they purchase the collectible, and upon trying to sell the collectible, often using the same marketplace from which they purchased the collectible, an expert determines that the collectible is counterfeit.

The risk to the collectibles industry includes buyers often feeling that the risk of a collectible being determined to be a counterfeit in the future, is so great for high value collectibles that the willingness of the buyer or market in general, to pay even market value, let alone ever increasing values, is impacted in such a manner that collectible values begin to be decreased by the inclusion of a risk discount for future counterfeit detection applied to the value by a future willing buyer of the collectible.

An even greater risk than lower values of collectibles, is that the collectibles industry reaches a point where the inability to authenticate a collectible can destroy the buyside of an entire industry and thus destroy a 160-year-old industry in its entirety.

Often only after counterfeit collectibles have been sold into the market does someone discover that the card is counterfeit and disclose to the industry what specific characteristics of the counterfeit enable future buyers of that collectible to determine if the collectible is genuine or not counterfeit.

By the time that a specific characteristic of a counterfeit collectible is discovered and becomes generally known by the industry, can a prospective buyer of the collectible be aware of the counterfeit and its characteristics and be able to protect themselves from buying a counterfeit version of the collectible.

However, all the buyers of the counterfeit collectible who purchased the collectible and retain that collectible, prior to someone disclosing the characteristic of the counterfeit become victims of the counterfeiter suffering what in many instances are large financial losses.

The value of a collectible is largely determined by its condition and scarcity.

The condition of a collectible is generally determined by an analysis of its physical characteristics such as centering of the image and location of that image on the material upon which it is placed, the corners of the collectible including missing stock such as fill, corner wear such as fray and corner surface wear, surface defects such as dents, pits, scratches, creases, print roller marks and others, edge wear such as indents, protrusions and edge surface wear and size of the collectible when an original size is known.

When a counterfeit or non-original collectibles is well produced, it often escapes detection by grading companies and is placed in a holder (slab) and either retained by its owner in the owner's personal collection (possibly sold in the future) or sold directly, after grading and being placed in a grading company holder (slab), on any of the numerous marketplaces including well established marketplaces such as eBay.

Once a collectible is placed in a holder (slab) it is more difficult to identify a specific characteristic of the collectible that may be used to determine that the collectible is counterfeit or not original. The time a collectible's genuineness and authenticity can be determined with its highest degree of assuredness is prior to it being placed in a holder (slab).

Utilizing any one or more of the aforementioned marker techniques, said marker may be identifiable as an explicit match to a defined Blockchain and/or non-fungible token “NFT”, such that every distinct trading card is identifiable and associated with a non-fungible blockchain token, for the purpose of tracking ownership, sale history, and card grading milestones, or other relevant metric associated with the trading card. As such, every individual card can be associated with a complete record of prior ownership and card grading events, to the extent that this blockchain-based history is publicly accessible and can be referenced for the purposes of provenance and anti-counterfeiting.

A collectible that is counterfeit or not original is generally accepted by the industry to be without its full market value and often worthless.

Collectibles, including cards, once placed in a holder and improperly authenticated as genuine continue to be traded, possibly many times over the years, as genuine when, in fact, they are counterfeit and if and when determined to be counterfeit, of no value.

When a collectible is graded and placed in a holder (slab) it is added to the known population in existence of that collectible and as a result, increases the population of that collectible, increasing the number of that collectible and reducing its scarcity, a major contributor to its market value.

A reduction in scarcity resulting from counterfeit cards being placed in the market decreases the collectible value.

Because counterfeit and not original collectibles are often sold in the marketplace, they increase the number of that collectible known to exist and decrease the collectible's value negatively impacting on the collectible's value.

Identifying a collectible as counterfeit or not original may be accomplished by determining specific characteristics of a counterfeit or not original collectible that differ from the original.

Failing to identify a collectible as counterfeit or not original often results in deception and a collector (purchaser) of the collectible paying the value of an original collectible. The failure to identify a collectible as not original or counterfeit facilitates fraud perpetrated by the creator of the counterfeit, results in loss to the innocent buyer of the collectible and results in profit for the creator of the collectible. Failure to identify a collectible as genuine and authentic encourages counterfeiters to continue creating counterfeit collectibles.

The way a collectible is determined to be counterfeit or not original today requires that a specific characteristic of the counterfeit or not original collectible be identified or otherwise known.

The disclosure provides various aspects of a system and method for determining if a collectible is original and not a counterfeit or a not original collectible without the requirement for, and use of, identifying a specific characteristic of a counterfeit or not original collectible.

The disclosure provides various aspects of a system and method for determining if a collectible is original and not a counterfeit and, in some instances with the aid of Blockchain and/or NFT technology, permits the card to be resold in the future with assurance that the original mark has not been altered after the card has been placed in a holder (e.g., slab).

An initial step in making a collectible (e.g., trading cards) may start with the design. This is where graphic artists will take the original golden image/photo of an athlete, or card subject image, and add card identification information. This identification info may include player name, stats, position, etc. to the front and back design of the card. In addition to player identification, the artist will add design flair to the card which may include different patterns, foils, effects, each and any of which may be customized and applied to any or all of the cards in a set or set designation, (e.g., serial, insert, etc.), etc. Constant innovation is needed to keep cards trending and popular. Once a front and back image is completed, the printing process begins

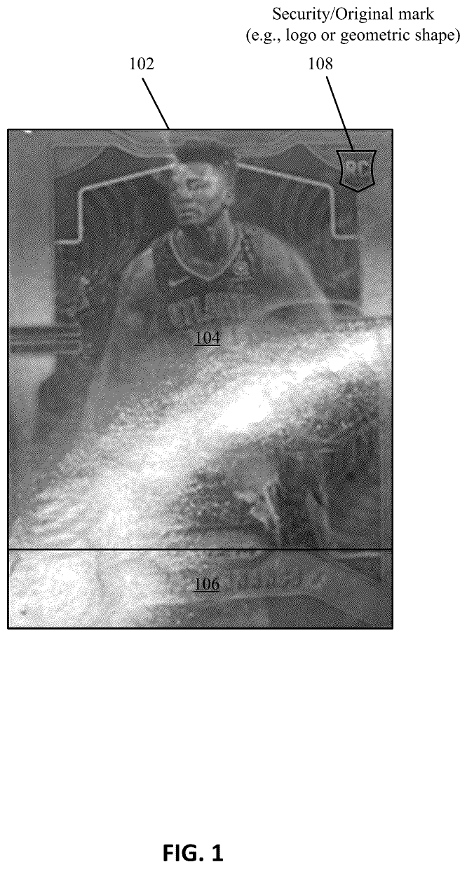

FIGS. 1-5 show one of several methods for producing a collectible.

An Image may be printed on clear Translucent Mylar sheets of paper. The completed front image is printed on the back side of a clear mylar sheet of paper, as shown for example in FIG. 1. In some aspects, a security or original mark 108 may be printed on the mylar sheet 102. The mylar sheet 102 may comprise a main region 104 and a bottom region 106. The main region 104 may include a photograph of the subject of the collectible, while the bottom region 106 may include identification information related to the subject shown in main region 104.

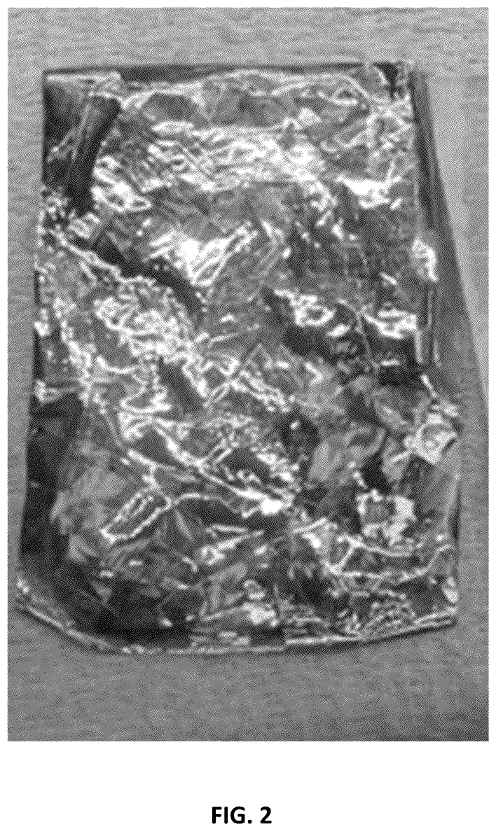

Foil Sheets. Some foil sheets are created by companies similar to Crown Roll Leaf, Inc. The mylar sheet may rest on top of the foil sheet to give the card a reflective and “refractor” feel. Adhesive is sandwiched between the mylar sheet and the foil to keep them from separation, as shown for example in FIG. 2

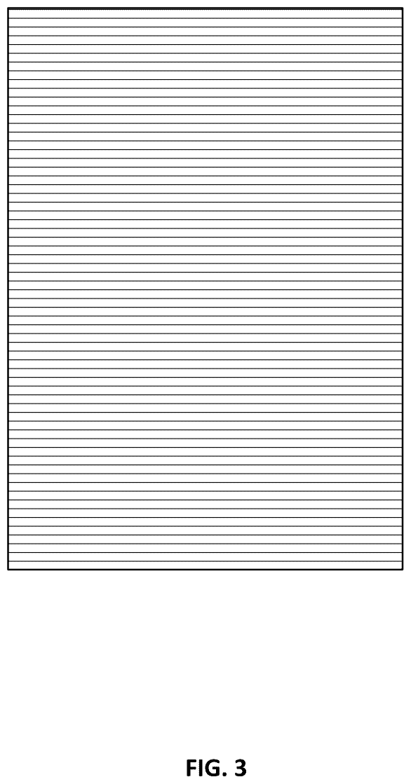

Glue Application. Light Glue is generally blue but may be any color. This glue/tack/strip is the adhesive that holds the foil onto the cardstock, as shown for example in FIG. 3

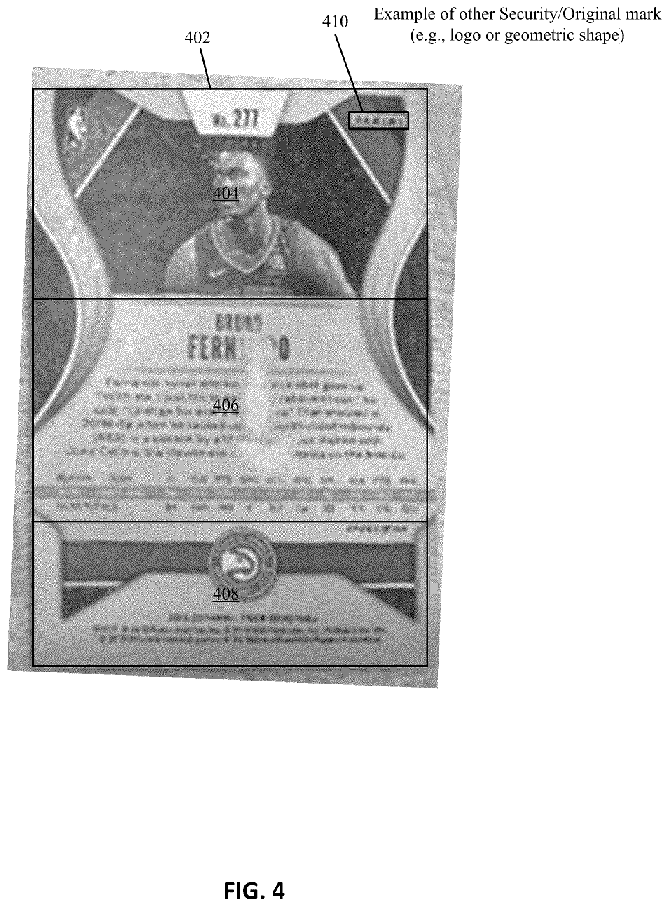

Printing on Back of collectible material that may be card stock. Blank white cardstock sheets (e.g., roughly 18 pt, or thinner or thicker, or the like) are run through the printing machines and the back side of trading card is printed directly from the printer to the cardstock, as shown for example in FIG. 4. In some aspects, a security or original mark 410 may be printed on the card stock 402. The card stock 402 may comprise an upper region 404, a middle region 406, and a lower region 408. The upper region may include a photograph of the subject of the collectible, which may be the subject of the collectible shown on the front of the collectible, as shown in FIG. 1. The middle region 406 may include statistical and/or biographical information related to the subject of the collectible. The lower region 408 may include team or club information of the subject of the collectible, as well as information related to the manufacturer of the collectible.

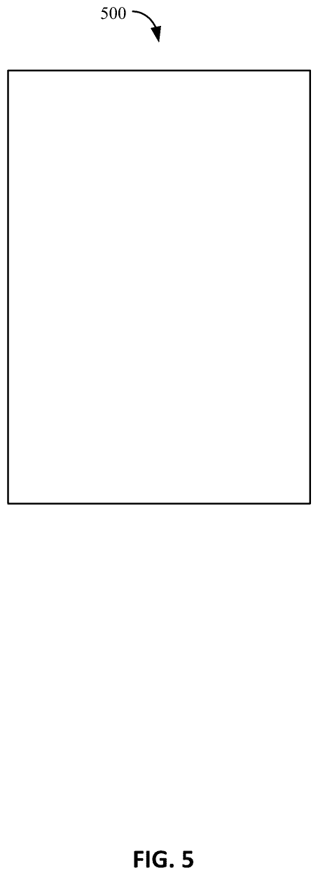

Film Layer. Once the back image is printed, the full back sheet goes through an additional film laminate to give the card a “glossy” feel, as shown for example in diagram 500 of FIG. 5.

In the example of FIG. 1, the security or original mark 108 may be on the mylar sheet that comprises the front image of the card or collectible, which may be in the form of a logo or geometric shape, or a component thereof. In some aspects, the security or original mark may be on other layers and the disclosure is not intended to be limited to the aspects disclosed herein. In some aspects, the security or original mark may be on any of the one or more layers that form the card or collectible. In some aspects, the card or collectible may comprise one or more marks, where the one or more marks may be on any of the one or more layers. The security or original mark may be visible or detected from one or more sides of the card or collectible. For example, the security or original mark may be visible or detectable from a front surface, a back surface, or both. In some aspects, the security or original mark may be visible to the unaided eye on at least one surface, while being detectable by a detection apparatus by way of the one or more surfaces of the card or collectible. The example method shown in FIGS. 1-5 is an example process and the disclosure is not intended to be limited to the examples provided herein. The process may be performed in any order to achieve the same results.

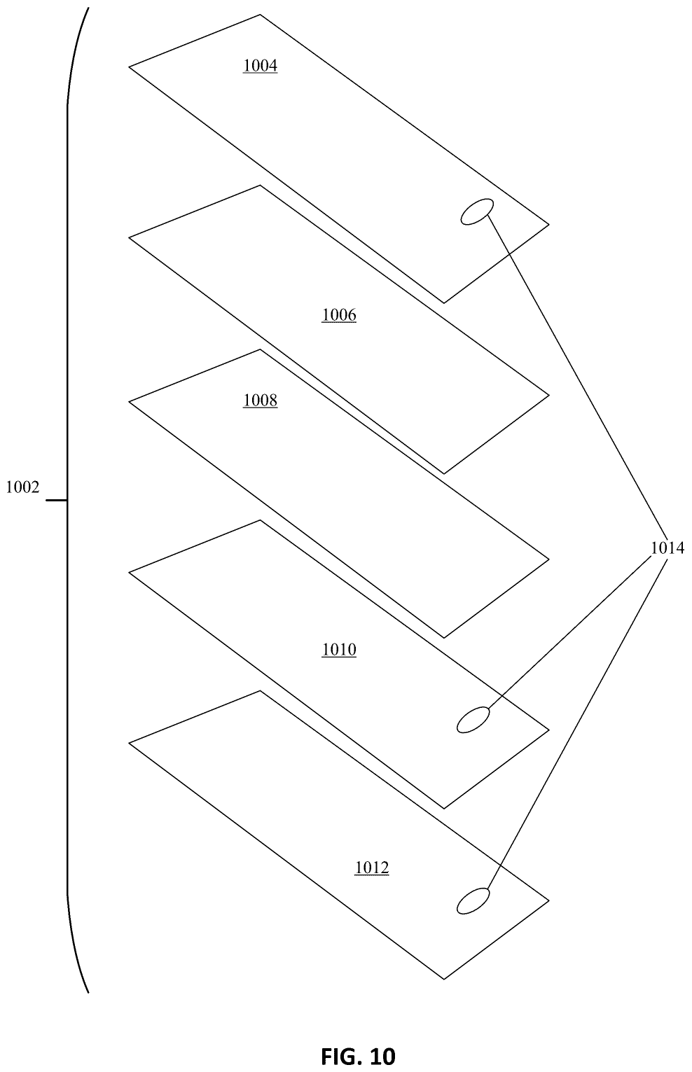

In one aspect of the disclosure, as broadly described herein, an “original mark” may be placed on any of the layers of the collectible indicating that the collectible is not a counterfeit or not original collectible. For example, the mark may be placed on a front face, a rear face, or on any of one or more layers interposed between the front face and the rear face. In some instances, the mark may be on an outer surface or an inner surface of the front face or the rear face. In some instances, the mark may be on any surface of any of the one or more layers interposed between the front face and the rear face of the collectible. For example, FIG. 10 shows an exploded view of a multi-layered collectible 1002 where the mark 1014 may be on an inner surface or an outer surface of the one or more layers (e.g., 1004, 1006, 1008, 1010, 1012) that form the collectible 1002. In some aspects, the collectible may comprise one or more marks 1014. In such instances, the one or more marks 1014 may be on any one of the one or more layers that form the collectible. In some aspects, the one or more marks 1014 may be on any surface of any one of the one or more layers that form the collectible.

The original mark is placed on any of the layers of the collectible which may indicate that the collectible was produced by a specific manufacturer, as well as other information related to the production of the collectible, such as but not limited to date of manufacture, location of manufacture, series of manufacture, or the like.

The original mark may or may not be seen with the unaided eye when looking at the surface of the collectible.

When the original mark is visible with an unaided eye from the surface of the collectible, where no other means of aiding the detection or identifying the existence of the original mark is necessary.

When the original mark is not visible on either the top, bottom, or any visible surface of the collectible with the unaided eye, such that other means of identifying the existence of the original mark may be utilized. For example, in some instances light from above or beneath the surface of the collectible may be used to confirm the existence of the original mark that is placed on one or more of the layers by the manufacturer. In some instances, refraction of light may be used to confirm the existence of the original mark. In some instances, sound wave directed at the original mark may be used to confirm the existence of the original mark. In some instances, a detection of a change of temperature when a material is used in the original mark that absorbs or emits a differing temperature from the unmarked area of the collectible may be used to confirm the existence of the original mark. In some instances, a unique print pattern of the original mark that is different from the print pattern of the collectible, may be identifiable by high resolution imaging may be used to confirm the existence of the original mark.

In some aspects, the other means of identifying the existence of the original mark may also be utilized in instances where the original mark is visible on any visible surface of the collectible. For example, the other means may be utilized to verify the original mark as being an authentic original mark. The original mark may be configured to react, reveal, or display a design or mark in response to the other means. For example, light may reflect or refract from the original mark is such a manner to display or reveal a design that is only visible in response to the reflected or refracted light. In some aspects, the original mark may be configured to display or reveal a design or alter the color of the original mark in response to sound waves, a change in temperature, x-ray, UV rays, wireless signals, or the like. The original mark responding to the other means of identifying the existence of the original mark may provide an additional layer of security or protection that the original mark is authentic and not a counterfeit.

The original mark may be in many different shapes or sizes. In some aspects, the original mark may be in the form of a geometric shape or a unique logo or design. In some aspects, the original mark may be comprised of one or more segments that as a collective form the original mark. For example, the original mark may be comprised of multiple segments of geometric and/or non-geometric shapes that form the original mark. In some aspects, the original mark may be comprised of multiple segments scattered throughout the collectible in a random or non-random fashion, wherein the multiple segments may or may not be in the form of a geometric shape or a unique logo or design. In some aspects, the original mark may be on one layer or on different layers of a multi-layered collectible. For example, at least a portion of original mark may be on multiple layers and may be arranged such that each layer of the original mark may be positioned to collectively form the original mark.

Any other means of differentiating the original mark from any other area of the collectible may be utilized to identify a collectible as original and/or not counterfeit.

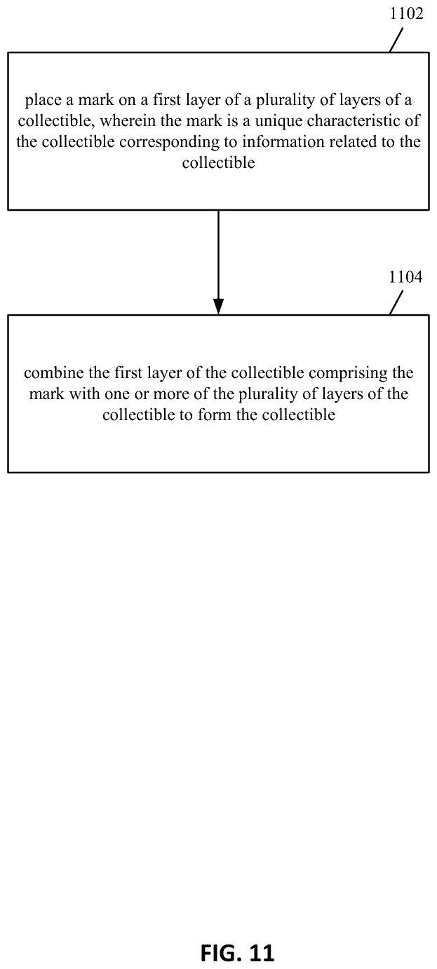

FIG. 11 is a flowchart of a method of marking a collectible. The method may be performed by a marking device. The marking device may be a component within the manufacturing process or is a component of a separate process that places the mark on one or more layers of a collectible before or after the collectible manufacturing process. In some aspects, the marking device may be configured to identify a location of the collectible on the collectible which comprises the unique characteristic of the collectible.

At 1102, the marking device may place a mark on a first layer of a plurality of layers of a collectible. The mark may comprise a unique characteristic of the collectible corresponding to information related to the collectible. In some aspects, the first layer comprises at least one of a front face of the collectible, a rear face of the collectible, or a layer interposed between the front face and the rear face of the collectible. In some aspects, the mark is on any surface of the plurality of layers of the collectible. In some aspects, the unique characteristic of the collectible comprises at least one of a print pattern that is a different print pattern than used elsewhere on the collectible, an alpha or numeric or alphanumeric identification of the collectible, a unique color red, green, blue (RGB) print that is not located elsewhere on the collectible, a font type that is not located elsewhere on the collectible, a font size that is not located elsewhere on the collectible, an object or device that emits a signal, light, color, dimension such as thickness or thinness, temperature, or any unique identification characteristic that is not duplicated anywhere else on the collectible, and may identify a location of the collectible, or an object placed on one or more layers or between layers of the collectible. In some aspects, the mark on the collectible is at least partially visible such that at least part of the mark is visible, or at least partially concealed such that at least part of the mark is not visible.

At 1104, the first layer of the collectible comprising the mark may be combined with one or more of the plurality of layers of the collectible to form the collectible. In some aspects, the mark on the collectible is at least partially visible such that at least part of the mark is visible, or at least partially concealed such that at least part of the mark is not visible. In some aspects, the mark is placed on a front surface or a rear surface of the collectible. In some aspects, the collectible comprises one or more layers, such that the mark is placed within or on any of the one or more layers of the collectible.

In some aspects, the presence of the mark may be identified or detected by use of a light source from one or more surfaces of the collectible. In some aspects, the presence of the mark may be identified or detected with an image capturing device. The image capturing device may comprise at least one of a scanner, camera, or any other image capture device. In some aspects, the presence of the mark may be identified or detected with the use of a detection device. The detection device may be configured to use at least one of light, sound, or electromagnetic signals to detect the mark. In some aspects, the presence of the mark may be identified or detected using temperature detection device. In some aspects, the presence of the mark may be identified or detected based on dimensions of at least part of the collectible. The dimensions of the mark utilized to detect the mark may comprise at least one of a size, thickness and/or width detection. In some aspects, the presence of the mark may be identified or detected based on a weight of the collectible. For example, the individual weights of the mark and of the collectible may be known, such that a collectible weighing within a predetermined weight may indicate that a mark is present within the collectible.

In some aspects, the mark comprises a collectible-specific registration or anti-counterfeiting marker associated with a blockchain database or non-fungible token. The mark may assist in the recording of relevant ownership information, provenance, card grading information, or the like of the collectible. For example, in some aspects, the mark may be linked or correspond to an online database, such that the mark may be scanned by a scanner or an optical device that allows for the online database to be accessed, such that the recorded information may be viewed. In some aspects, the mark may comprise a wireless sensor (e.g., RFID, NFC, or the like) that may be detected using radio waves, and may allow a wireless device to access the recoded information associated with the mark.

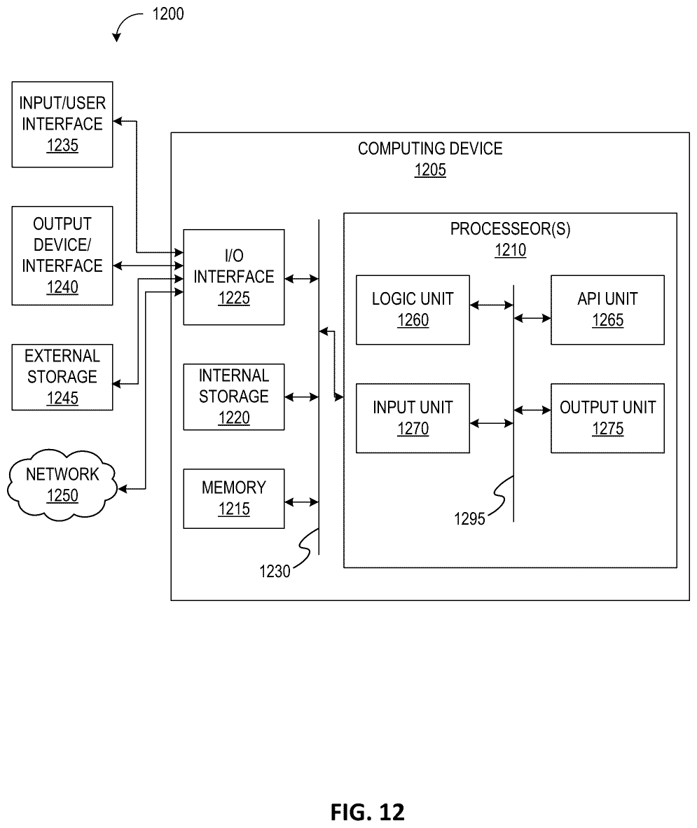

FIG. 12 illustrates an example computing environment with an example computer device suitable for use in some example implementations, as shown in connection with any of FIGS. 1-11. The computing environment can be used to facilitate implementation of the aspects illustrated in FIGS. 1-11. Further, any of the example implementations described herein can be implemented based on architectures, APIs, microservice systems, and so on as described in connection with FIGS. 1-11. Computer device 1205 in computing environment 1200 can include one or more processing units, cores, or processors 1210, memory 1215 (e.g., RAM, ROM, and/or the like), internal storage 1220 (e.g., magnetic, optical, solid state storage, and/or organic), and/or I/O interface 1225, any of which can be coupled on a communication mechanism or bus 1230 for communicating information or embedded in the computer device 1205. I/O interface 1225 is also configured to receive images from cameras or provide images to projectors or displays, depending on the desired implementation.

Computer device 1205 can be communicatively coupled to input/user interface 1235 and output device/interface 1240. Either one or both of input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via I/O interface 1225) to external storage 1245 and network 1250 for communicating with any number of networked components, devices, and systems, including one or more computer devices of the same or different configuration. Computer device 1205 or any connected computer device can be functioning as, providing services of, or referred to as a server, client, thin server, general machine, special-purpose machine, or another label.

I/O interface 1225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided. Processor(s) 1210 can be in the form of hardware processors such as central processing units (CPUs) or in a combination of hardware and software units.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1225, input unit 1270, output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide output based on the calculations described in example implementations.

Processor(s) 1210 can be configured to execute instructions for a method, the instructions involving obtaining production data corresponding to production machinery utilized during the production process; obtaining operator data corresponding to an operator operating the production machinery; obtaining material data corresponding to material used by at least one of the operator or the production machinery in the production process; calculating a calculation data set based on the production data, the operator data, and the material data; and performing an analysis at least on the operator data based on results of the calculation data set, for example, in any of FIGS. 1 to 11.

Processor(s) 1210 can be configured to execute instructions for a method, the method providing, as output, a user interface comprising results of the analysis of at least the operator data based on the results of the calculation data set, for example, in any of FIGS. 1 to 11.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (e.g., software stored on memory 1215), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

1. An apparatus for marking a collectible, comprising:
at least one memory; and
at least one processor coupled to the at least one memory and is configured to cause the apparatus to:
place a mark on the collectible that is a unique characteristic of the collectible that authenticates the collectible as being an original collectible created, produced, or manufactured at a specific location, time or by an entity identified as such by a manufacturer of the collectible.

2. The apparatus of claim 1, wherein the marking device identifies a location of the collectible on the collectible which comprises the unique characteristic of the collectible.

3. The apparatus of claim 1, wherein the marking device is a component within the manufacturing process or is a separate process that places the mark on one or more layers before or after the collectible manufacturing process.

4. The apparatus of claim 1, wherein the unique characteristic of the collectible comprises at least one of:
a print pattern that is a different print pattern than used elsewhere on the collectible,
an alpha or numeric or alphanumeric identification,
a unique color red, green, blue (RGB) print that is not located elsewhere on the collectible,
a font type that is not located elsewhere on the collectible,
a font size that is not located elsewhere on the collectible,
an object or device that emits a signal, light, color, dimension such as thickness or thinness, temperature, or any unique identification characteristic that is not duplicated anywhere else on the collectible, and may identify a location of the collectible, or
an object placed on one or more layers or between layers of the collectible.

5. The apparatus of claim 1, wherein the collectible has one or more layers wherein,
the mark is placed on a top if the collectible is comprised of one layer,
the mark is placed on a bottom if the collectible is comprised of one layer, or
the mark is placed on a layer in between the top and the bottom if the collectible is comprised of more than one layer.

6. The apparatus of claim 1, wherein the mark on the collectible is at least partially visible such that at least part of the mark is visible, or at least partially concealed such that at least part of the mark is not visible.

7. The apparatus of claim 1, wherein the mark is placed on a front surface or a rear surface of the collectible.

8. The apparatus of claim 1, wherein the collectible is comprised of one or more layers, wherein the mark is placed within or on any of the one or more layers of the collectible.

9. The apparatus of claim 1, wherein presence of the mark is identified by use of a light source from one or more surfaces of the collectible.

10. The apparatus of claim 1, wherein the presence of the mark is identified with an image capturing device, wherein the image capturing device comprises at least one of a scanner, camera, or any other image capture device.

11. The apparatus of claim 1, wherein the presence of the mark is identified with the use of a detection device, wherein the detection device is configured to use at least one of light, sound, or electromagnetic signals to detect the mark.

12. The apparatus of claim 1, wherein the presence of the mark is identified using temperature detection device.

13. The apparatus of claim 1, wherein the presence of the mark is identified using dimension, wherein the dimension comprises at least one of a size, thickness and/or width detection.

14. The apparatus of claim 1, wherein the presence of the mark is identified using weight of the collectible.

15. The apparatus of claim 1, wherein the mark comprises a collectible-specific registration or anti-counterfeiting marker associated with a blockchain database or non-fungible token to record a record of relevant ownership information, provenance, or card grading information.

16. A method of marking a collectible, comprising:
placing a mark on a first layer of a plurality of layers of a collectible, wherein the mark is a unique characteristic of the collectible corresponding to information related to the collectible; and
combining the first layer of the collectible comprising the mark with one or more of the plurality of layers of the collectible to form the collectible.

17. The method of claim 16, wherein the first layer comprises at least one of a front face of the collectible, a rear face of the collectible, or a layer interposed between the front face and the rear face of the collectible.

18. The method of claim 16, wherein the mark is on any surface of the plurality of layers of the collectible.

19. The method of claim 16, wherein the unique characteristic of the collectible comprises at least one of:
a print pattern that is a different print pattern than used elsewhere on the collectible,
an alpha or numeric or alphanumeric identification,
a unique color red, green, blue (RGB) print that is not located elsewhere on the collectible,
a font type that is not located elsewhere on the collectible,
a font size that is not located elsewhere on the collectible,
an object or device that emits a signal, light, color, dimension such as thickness or thinness, temperature, or any unique identification characteristic that is not duplicated anywhere else on the collectible, and may identify a location of the collectible, or
an object placed on one or more layers or between layers of the collectible.

20. The method of claim 16, wherein the mark on the collectible is at least partially visible such that at least part of the mark is visible, or at least partially concealed such that at least part of the mark is not visible.
